(19) United States
(12) Patent Application Publication
(10) Pub. No.: US 2008/0173694 A1
(43) Pub. Date: Jul. 24, 2008

(54) Ultrasonic welding system

(76) Inventors: Hans-Peter Wild, Eppelheim (DE); Eberhard Kraft, Neckarbischofsheim (DE); Frank Lechert, Weinheim (DE)

Correspondence Address: STROOCK & STROOCK & LAVAN LLP, 180 MAIDEN LANE, NEW YORK, NY, 10038, US

(21) Appl. No.: 12/001,698

(22) Filed: Dec. 11, 2007

(30) Foreign Application Priority Data
Dec. 11, 2006 (EP) 06025608.8

(51) Int. Cl. B23K 1/06

(52) U.S. Cl. 228/1.1

(57) ABSTRACT

An ultrasonic welding system is provided for creating an ultrasonically welded seam in a plurality of layers of a material, for example a foil bag having a plurality of foil layers. The system preferably includes a sonotrode and an anvil constructed and arranged to apply a welding force at an angle of less than 90° with respect to the downward force of gravity. Accordingly, a vertical welding force can be provided on the foil layers to weld the foil layers together from the bottom upward.

### BACKGROUND OF THE INVENTION

This invention relates, in general, to a system for ultrasonic welding a plurality of layers of a material, more specifically relatively thin layers of a material. For example, the layers of material can comprise foil layers comprising thermoplastic materials, metals such as aluminum, and/or any other material that can be welded ultrasonically. An ultrasonic welding system can be suitable for forming containers, such as foil bags for food, for example, drink pouches.

An exemplary ultrasonic welding system currently available includes a sonotrode for generating ultrasonic vibrations. The system also includes an anvil spaced apart from the sonotrode to receive the foil layers between the sonotrode and the anvil for ultrasonic welding the layers together. The sonotrode and/or anvil are typically displaced toward each other onto the foil layers at a predetermined pressure. During welding, the sonotrode and anvil typically apply the predetermined pressure horizontally on the foil layers, more specifically, at an angle of 90° with respect to the direction of gravity.

The anvil can be mounted to vibrate and urged toward the sonotrode. The ultrasonic vibrations can produce a frictional heat on the joining surfaces between the foil layers, melting the foil material and permitting the melted material to flow viscously. Therefore, the foil layers can be welded to one another after cooling, thus forming a welded seam between the foil layers.

A potential drawback of the systems known in the art is that the material of the foil layers can be displaced resulting from the impact caused by the ultrasonic vibrations, and/or gravity acting on the material. This displacement can occur even when the foil layers are retained in place by a holding device, or supported by a conveyor belt, etc. Such displacement can result in inconsistent and imprecise welding seams, which can be unfavorable in certain situations, such as when sealing a foil bag filled with a beverage. Filled foil bags are usually transported in an upright position and the foil material proximate or at the welded seam bears a portion of the weight, and thus can be more susceptible to the imprecise welded seams.

In light of the shortcomings described above, it is desirable to provide an ultrasonic welding system, which facilitates providing a more precise welded seam than systems currently available.

### SUMMARY

Generally speaking, the present invention is directed toward an ultrasonic welding system suitable for sealing a filled foil bag. The ultrasonic welding system can include a sonotrode and an anvil, which collectively apply pressure and ultrasonic vibrations on the foil layers to create a welded seam. The sonotrode and/or the anvil or the anvil's loading device can be inclined to apply an upward vertical force on the foil layers to counteract the downward force of gravity in order to substantially eliminate the negative effect of gravity discussed above. Therefore, the welded seam can be formed at the predetermined location rather than being displaced.

An embodiment of the invention can also compensate for the short-term release of the foil layers between the sonotrode and the anvil, and thus can prevent the welded seam from being displaced upward.

Preferably, the effective planes of the sonotrode and the anvil at which the sonotrode and anvil contact the foil layers are parallel to each other and extend vertically, preferably parallel to the downward force of gravity. Such an arrangement can facilitate avoiding the foil layers from being bent.

An embodiment of the system can provide more than one welded seam, for example, by providing, at either the sonotrode or the anvil, or both, a plurality of protrusions having a gap therebetween.

An embodiment of the system can also include a conveying system for transporting the filled foil bags in an upright position to and from the receiving gape between the sonotrode and the anvil. A clamping device can further support the foil bags.

An object of the invention is to provide an improved ultrasonic welding system as described herein.

Other objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE FIGURES

For a fuller understanding of the invention, reference is had to the following description, taken in connection with the accompanying drawings, in which:

FIG. 1 is a schematic view of a portion of an ultrasonic welding system in accordance with an embodiment of the invention;

FIG. 2 is an enlarged view of area A of FIG. 1;

FIG. 3 is a schematic view of an ultrasonic welding station in a second position in accordance with an embodiment of the invention; and

FIG. 4 is a schematic representation of the force provided by a system in accordance with an embodiment of the invention.

### DETAILED DESCRIPTION

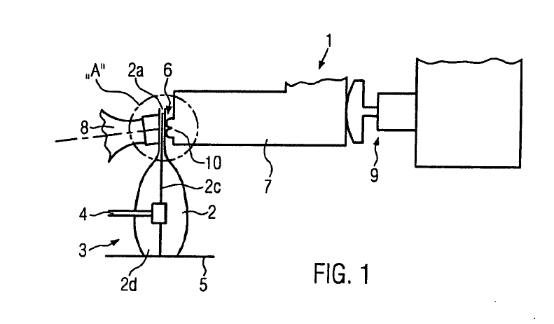

Reference is made to FIGS. 1-3, wherein an embodiment of an ultrasonic welding system 1 is illustrated. As shown in FIG. 1, the system 1 can include an anvil 7 and a sonotrode 8, such as an ultrasonic hammer. A receiving gap 6 is preferably between the anvil 7 and the sonotrode 8, such that a plurality of foil layers of a foil bag 2, such as a beverage bag, can be received in the receiving gap 6.

The foil bag 2 preferably includes two sides having a sealed bottom 2d and sides 2c and an opening through which a material can be filled into the foil bag 2, previously prior to the foil bag 2 being received in the receiving gap 6. Each side of the foil bag preferably includes a plurality of layers. The layers can comprise the same or different materials, for example, thermoplastic foils, metal foils, etc. The system 1 preferably welds the two sides to close and seal the opening.

In accordance with an exemplary embodiment of the system 1, the foil bags 2 can be transported in an upright position via a conveyor 3 to the ultrasonic welding system 1. The foil bags 2 are preferably previously filled, and thus can have bulging side walls resulting from the weight of the filling. The conveyor 3 can include one or more grippers 4 for grasping one or more side seams 2c of the foil bags 2, thus supporting foil bags 2 as they are being transported to and from the ultrasonic welding system 1. The conveyor 3 may further include an additional support, such as a conveying belt having a support surface 5 on which the foil bags 2 can be transported. Therefore, the conveyor 3 can support the weight of the filled foil bag 2 as it is being transported.

The foil bag 2 can be transported into the receiving gap 6 and thus between the anvil 7 and the sonotrode 8. The receiving gap 6 can be reduced by displacing the anvil 7 and/or the sonotrode 8 toward each other to the welding position until the side walls of the foil bags 2 contact each other. When in the welding position, the sonotrode 8 can provide ultrasonic vibrations, and therefore provides ultrasonic energy to both the side walls of the foil bags 2. The material of the side wall receiving the ultrasonic energy can preferably melt and weld to the melted material of the opposing side wall.

The pressure applied on the side walls by the anvil 7 and the sonotrode 8 can be determined and buffered by a preloading mechanism 9, which is preferably spring-loaded to vibrate, and more preferably urges the anvil 7 toward sonotrode 8.

Referring to FIGS. 1-3, anvil 7 can include one or more protrusions 10 protruding from a base surface 10a toward sonotrode 8. The position of the protrusions 10 preferably corresponds to and thus determines the location of the welded seam formed on the foil bag 2. In the embodiment shown, two protrusions 10 are provided in a vertical arrangement wherein one protrusion is above the other with a gap therebetween.

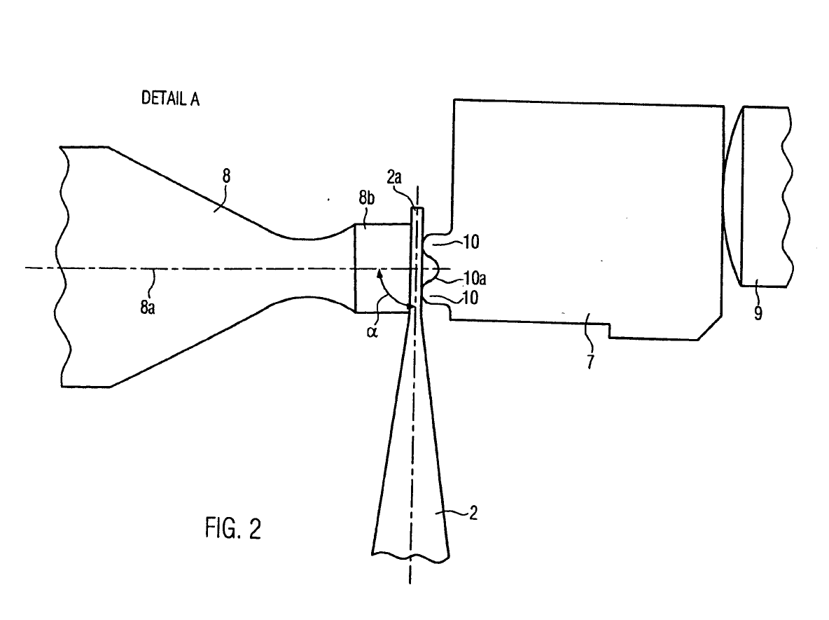

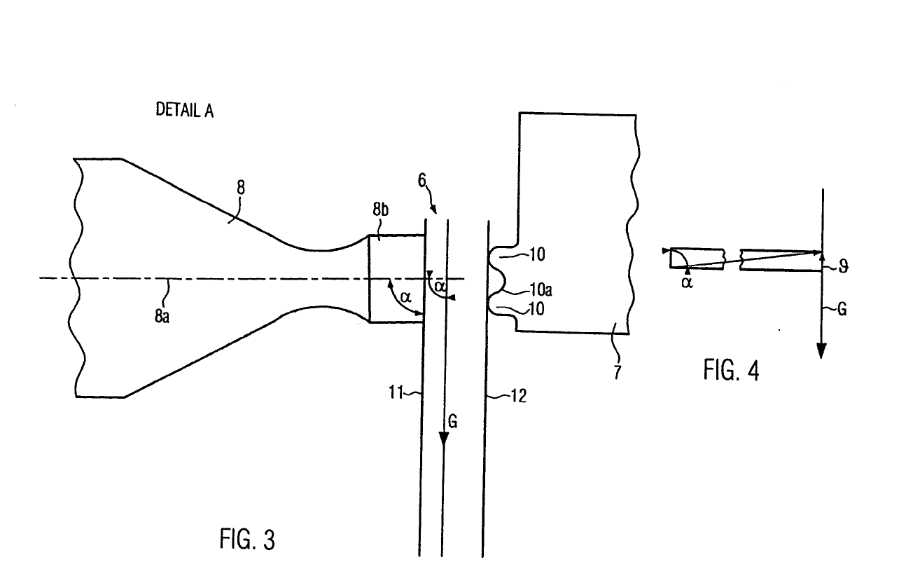

Referring to the exemplary embodiment shown in FIGS. 2-3, the sonotrode 8 has a center line 8a that is parallel to the direction of force applied by sonotrode 8 toward anvil 7. Sonotrode 8 is preferably constructed and arranged such that the center line 8a is at an angle α from a direction G of the force of gravity. Preferably, angle α is greater than about 70°, more preferably between about 80° and 89.5°, more preferably between about 85° and 89°, more preferably between about 87° and 89°, most preferably about 88°, with respect to direction G. More specifically, a 2° deviation from the horizontal, namely the direction perpendicular to direction G of the force of gravity, is preferred.

FIG. 4 illustrates an example of the force being applied on the foil bag 2 during welding. In the embodiment shown, the sonotrode 8 is displaced toward the right to apply a pressure on the foil bag 2 toward anvil 7 at an angle of α with respect to direction G during welding. Thus a welding force is applied on the foil bag in a direction parallel to center line 8a, and includes a horizontal force and an upward vertical force θ.

Moreover, the sonotrode 8 preferably provides ultrasonic vibrations, thus applying sound pressure onto the foil bag 2 toward the anvil 7. The sound pressure is preferably exerted in a direction parallel to the center line 8a of sonotrode 8, and therefore the direction of sound pressure coincides with the pressure applied by sonotrode 8. Therefore, the sound pressure is also provided at angle α with respect to direction G. The upward vertical force θ is preferably created by a combination of the vertical component of the pressure of sonotrode 8 being displaced toward anvil 7 and the vertical component of the sound pressure applied by the ultrasonic vibrations.

Vertical force θ is preferably an upward force, and thus the sonotrode 8 applies a force in a direction opposite from the direction G of gravity, thus counteracting the force of gravity. For example, the oblique angle at which the sonotrode 8 is displaced toward anvil 7 can assure that the foil layers of the foil bag 2 can be welded together from the lower end obliquely to the upper end. Therefore, the impact of inertia of the sonotrode 8 and the anvil 7, as well as the tensile forces introduced into the foil layers from the bulging side walls of the foil bag 2, the unsupported weight of the filled foil bag 2, etc. can be compensated for. Thus a linearly extending welded seal that has not “slipped out of place” can be provided.

In accordance with the exemplary embodiments shown, sonotrode 8 has a sonotrode plane 11 and the anvil 7 has an anvil plane 12. The sonotrode plane 11 and anvil plane 12 are preferably parallel with respect to each other, thus providing a constant width of receiving gap 6. Preferably the sonotrode plane 11 and the anvil plane 12 are also parallel to direction G of the force of gravity. In accordance with an exemplary embodiment, sonotrode 8 contacts the foil layers at sonotrode plane 11 and the anvil 7 contacts the foil layers at anvil plane 12. Thus a head 8b of sonotrode 8 preferably has a front surface that lies in sonotrode plane 11, which creates an angle α with the center line 8a of the sonotrode 8. Alternatively, one or more of the sonotrode plane 11 and the anvil plane 12 can extend obliquely with respect to direction G. Preferably, if the planes 11, 12 are not parallel to each other, the slightly bent portion of the foil layers above the welding seam does not interfere with the portion beneath the welding seam.

Referring to FIG. 1, an example of the method in which an ultrasonic welded seam is created will be described herein. Foil bag 2 is preferably supported on surface 5 and transported by conveyor 3 until a portion of the foil bag 2 comprising a plurality of foil layers is positioned within receiving gap 6 between the anvil 7 and the sonotrode 8. The anvil 7 can be displaced toward the sonotrode 8 to apply a welding force on the foil layers positioned within the receiving gap 6. The welding force preferably is provided at an angle α with respect to direction G of the force of gravity, and thus provides an upward force θ as well as a horizontal force on the foil layers. The foil layers can be welded from the bottom up as a result of the upward force θ provided by the system 1.

The angle α can be determined according to the downward vertical force that is being counteracted. For example, the weight of the filled foil bag 2, the downward portion of the bulging force created by the bulging of the side walls of the foil bag 2, etc., collectively the “total downward force,” can be considered in determining the desired angle α. Preferably, the angle α is provided to substantially prevent both downward and upward displacement of the material of the foil layers. In accordance with an exemplary embodiment, the upward force θ can be greater than the total downward force. An appropriate counterforce may be provided to prevent the foil bag 2 from being lifted upward. For example, a holding mechanism such as gripper 4 can be provided to grasp the side seams 2c of the foil bag 2 to prevent the foil bag 2 from being lifted.

Whereas the examples described herein provides for an inclined sonotrode 8, it is to be understood that anvil 7 or the preloading mechanism 9 thereof can be inclined at an angle α without deviating from the scope of the invention. Alternatively, both the sonotrode 8 and the anvil 7 or preloading mechanism 9 can be inclined to produce the desired vertical force θ as a matter of application specific design choice without deviating from the scope of the invention.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-9. (canceled)

10. An ultrasonic welding system comprising:
a sonotrode having a sonotrode plane;
an anvil having an anvil plane;
the sonotrode and the anvil being constructed and arranged to provide a gap between the sonotrode plane and the anvil plane for receiving a plurality of foil layers and to apply an upward force on the foil layers during welding, the upward force being applied at a direction opposite to the direction of gravity.

11. The system of claim 10, wherein the upward force is applied on the foil layers at an angle of more than about 70° with respect to the direction of gravity.

12. The system of claim 10, wherein the upward force is applied on the foil layers at an angle between about 80° and 89.5° with respect to the direction of gravity.

13. The system of claim 10, wherein the upward force is applied on the foil layers at an angle between about 85° and 89° with respect to the direction of gravity.

14. The system of claim 10, wherein the upward force is applied on the foil layers at an angle between about 87° and 89° with respect to the direction of gravity.

15. The system of claim 10, wherein the upward force is applied on the foil layers at an angle of about 88° with respect to the direction of gravity.

16. The system of claim 10, wherein the sonotrode is inclined at an angle between about 0° and 90° with respect to the direction of gravity.

17. The system of claim 10, wherein the sonotrode plane is parallel to the direction of gravity.

18. The system of claim 10, wherein the anvil is inclined at an angle between 0° and 90° with respect to the direction of gravity.

19. The system of claim 10, wherein the anvil plane is parallel to the direction of gravity.

20. The system of claim 10, wherein the sonotrode includes a plurality of protrusions having a gap therebetween.

21. The system of claim 10, further comprising a conveying device for transporting foil bags filled with a filling, the foil bags being transported in an upright position.

22. The system of claim 21, wherein the conveying device includes a compressing arrangement for laterally compressing the foil layers.

23. An ultrasonic welding system comprising:
a sonotrode;
an anvil;
wherein the sonotrode and the anvil are arranged to provide a receiving gap therebetween wherein a plurality of foil layers are received;
wherein the sonotrode and the anvil are constructed and arranged to be displaced toward each other until the sonotrode and the anvil contact the foil layers;
wherein the sonotrode and the anvil apply a force on the foil layers during welding that is opposed to gravity at an angle of between 70° and 90°.
